(19) United States
(12) Patent Application Publication
(10) Pub. No.: US 2019/0292112 A1
(43) Pub. Date: Sep. 26, 2019

(54) Use of Silicon as a Stimulant for Iron Absorption in a Plant

(71) Applicant: AGRO INNOVATION INTERNATIONAL, Saint-Malo (FR)

(72) Inventors: Jean-Claude YVIN, Saint-Malo (FR); Mustapha ARKOUN, Saint-Malo (FR)

(21) Appl. No.: 16/302,803

(22) PCT Filed: May 18, 2017
(86) PCT No.: PCT/FR2017/051208

§ 371 Date: Nov. 19, 2018

(30) Foreign Application Priority Data
May 19, 2016 (FR) 1654442

(51) Int. Cl. C05D 9/02

(52) U.S. Cl. CPC C05D 9/02

(57) ABSTRACT

The present invention provides the use of silicon as a stimulant for iron absorption in a plant.

It also provides a method of stimulating iron absorption in a plant, characterized in that it comprises supplying said plant or soils with an effective quantity of silicon.

### TECHNICAL FIELD

The invention relates to a novel use of silicon to stimulate iron absorption in a plant.

### PRIOR ART

Plants need to assimilate nutrient elements in order to ensure that they grow normally. In particular, plants need to assimilate essential constituents such as iron for the synthesis of proteins. The majority of plants obtain iron from the soil and they use this element for synthesizing proteins via absorption and synthesis mechanisms more or less complex. Thus, iron plays a key role in cultivation, both as regards the yield and the quality of the produce. It is therefore vital to provide plants with iron in sufficient quantity and in a form that can readily be assimilated by the plant.

Iron is an essential element for synthesizing chlorophyll. Chlorophyll is necessary for photosynthesis and gives plants their green color. A deficiency of iron, sometimes known as iron chlorosis, leads to a change in the photosynthetic activity of the plant and reduces the quantity of chlorophyll that is synthesized. A reduction in the quantity of chlorophyll reduces the growth of the plant and its resistance to stress. It becomes more sensitive to changes in temperature or to diseases. Plants with an iron deficiency exhibit in particular discoloration of the foliage, which turns yellowish, starting with young shoots and finishing with leaf death.

Iron deficiencies can affect a very large number of plants. Plants cultivated on chalky soils are particularly prone to iron deficiencies. Excess water caused by high precipitation or poor drainage are also likely to induce iron deficiencies.

Although iron is abundant in the soil, its absorption by roots is complicated, because under oxidizing conditions or at alkaline pH, the Fe⁺⁺ cation (ferrous iron) disappears because it is transformed into ferric oxide (Fe⁺⁺⁺), which cannot be assimilated by plants.

Plants have developed specific strategies to enable them to absorb iron:
strategy 1, in which iron is absorbed directly in the form of ferrous iron (Fe⁺⁺); this applies to tomatoes, peas, or arabidopsis, for example; and
strategy 2, in which the plant (for example corn (i.e. maize), barley, or rice) produces natural molecules or phytosiderophores that bind to iron in the form of ferric iron (Fe⁺⁺⁺), allowing it to be assimilated, which molecules are released into the rhizosphere.

In order to prevent iron deficiency, the plant can be supplemented with a source of iron, in particular by supplying fertilizing compositions comprising a source of iron. The fertilizing compositions that are generally used mean that iron can be supplied in sufficient quantity to ensure that the plant grows normally.

There are two types of iron-based fertilizing: fertilizing compositions based on non-chelated iron, and fertilizing compositions based on chelated iron.

Fertilizing compositions based on non-chelated iron, such as iron sulfate heptahydrate, have a tendency to react with the carbonates contained in the soil and to lose their effectiveness. In addition, the Fe(II) ions contained in fertilizer can readily be oxidized into Fe(III), the form which the plant is less able to assimilate than Fe(II). Thus, fertilizing compositions based on non-chelated iron are unstable and they vary in effectiveness.

Fertilizing compositions based on chelated iron constitute the form that can best be assimilated by the plant. Chelated iron is more stable: in particular, it is available for longer compared with non-chelated iron. Examples of the chelating agents used in fertilizing compositions include EDDHA, EDTA, DTPA, EDDHSA, EDDHMA and/or organic matter in the soil, for example of the humate or citrate type. However, such chelating agents are expensive and the fertilizing compositions containing them represent a non-negligible cost to the farmer. This cost is all the greater, because several applications are generally necessary in order to prevent the risk of iron deficiency. In fact, chelated iron compositions are soluble in water and can readily be swept away by water (the phenomenon of leaching). Thus, a fertilizer composition based on chelated iron needs to be reapplied regularly.

It is also essential for the plant to be capable of correctly assimilating the nutrient elements present in their environment, in particular the iron present in the fertilizing compositions or naturally present in the soil. Thus, a plant that is capable of assimilating a larger quantity of iron is less sensitive to risks associated with deficiency and grows more rapidly. Thus, the quantities of iron in the fertilizing compositions can be reduced, which means that (i) there is a substantial financial saving during fertilization campaigns, and (ii) losses of iron by leaching or blocking in the soil can be reduced, and thus the impact of fertilization campaigns on the environment can be reduced.

There is therefore a need to develop treatments that can be used to stimulate iron absorption in the plant.

It is in this context that the Applicant has demonstrated—and this constitutes the basis of the present invention—that silicon can be used to stimulate iron absorption in a plant.

### SUMMARY OF THE INVENTION

Thus, the present invention, which is applicable in the field of agriculture, seeks to provide a novel use of silicon as a stimulant for iron absorption in a plant.

In accordance with a first aspect, the invention provides the use of silicon as a stimulant for iron absorption in a plant.

In accordance with a second aspect, the invention provides a method for stimulating iron absorption in a plant, characterized in that it comprises supplying an effective quantity of silicon to said plant or to soils.

### DETAILED DESCRIPTION OF THE INVENTION

The present invention arises from the surprising advantages demonstrated by the inventors of the stimulating effect of silicon on iron absorption in a plant.

Specifically, the invention provides the use of silicon as a stimulant for iron absorption in a plant.

In the context of the present invention, the expression “plant” is used to designate the plant considered as a whole, including its root system, its vegetative system, grains, seeds, and fruits.

The use of silicon allows an increased iron absorption (i.e. stimulation). This stimulation of absorption can be used to improve the health of the plant, thereby satisfying requirements for growth of the crop as expressed in particular in terms of improving the yield and the quality of the harvest a. The use of silicon in accordance with the invention also means that the efficiency of fertilization can be improved by reducing the quantities of iron used in the fertilizing compositions.

In the context of the present invention, the term “fertilizing composition” is used to designate any product the use of which is intended to guarantee or improve the physical, chemical, or biological properties of soils as well as nutrition of the plants. An example of such a composition is a fertilizer applied via the roots or via the leaves. As is known, fertilizers are defined as fertilizing materials having the principal function of supplying plants with nutrient elements (major fertilizing elements, secondary fertilizing elements, and oligo-elements). The repeated application of iron-based fertilizer to compensate for losses by leaching could represent a substantial financial loss for the farmer. One possible response to reducing the frequency of application of iron-based fertilizers consists of improving the efficiency of absorption of iron by the plants. This constitutes one of the principal advantages of the present invention, which arises directly from stimulating iron absorption.

In the context of the invention, the term “silicon” means the chemical element with the symbol Si in all of its forms. In particular, this includes silica (also known by the term “silicon oxide”), silicates (for example SiO₃²⁻ and SiO₄⁴⁻), and combined silicates. Silica exists in crystalline or amorphous forms in the free state. In its crystalline form, silica is in the form of non-molecular crystals formed by tetrahedral SiO₄ units bonded together via oxygen atoms in a regular manner, such as in quartz. In its amorphous form, silica is in the form of silicon dioxide (SiO₂), such as in glass. Silica is an acidic oxide that reacts with basic oxides in order to produce silicates, in particular SiO₃²⁻ and SiO₄⁴⁻. Silicates are capable of combining with other metal atoms such as, for example, aluminum (Al), iron (Fe), magnesium (Mg), calcium (Ca), sodium (Na), or potassium (K). The combined silicates obtained in this manner are respectively aluminum silicate (Al₂SiO₃), iron silicate (Fe₂SiO₃), magnesium silicate (Mg₂SiO₃), calcium silicate (Ca₂SiO₃), sodium silicate (Na₂SiO₃) and potassium silicate (K₂SiO₃). In a particular embodiment, silicon is supplied to the plant in the form of sodium silicate (Na₂SiO₃), potassium silicate (K₂SiO₃), and/or their derivatives. The derivatives may include K₂SiO₄ and Na₂SiO₄ forms, for example.

Advantageously, the silicon supplied to the plant may derive from various sources, for example from solid mineral silica (i.e. diatomaceous earth or sand), from liquid mineral silica (i.e. orthosilicic acid, Si(OH)₄), from vitreous products based on silicon (for example glass powders or fibers), and/or from organic silica.

Diatoms are marine micro-algae that secrete a silica skeleton that are found in natural quarries in the form of fossils. Diatomaceous earth that is generally extracted from these natural quarries is rich in fossilized diatoms. Diatomaceous earth is essentially constituted by silicon dioxide (SiO₂).

The term “vitreous products based on silicon” is used to mean any powdered vitreous material comprising (i) one or more mineral elements, in particular one or more mineral elements selected from potassium (K), phosphorus (P), calcium (Ca), magnesium (Mg), sulfur (S), iron (Fe), boron (B), manganese (Mn), copper (Cu) and molybdenum (Mo), and (ii) silicon. The mineral elements are preferably in the form of oxides.

Organic silica corresponds to silanol (CH₃Si(OH)₃). Organic silica may in particular originate from crop residues that are rich in silicon, for example silicon-accumulating plants such as sugar cane, rice, bamboo, sorghum, maize (corn), wheat, and grasses.

In the plant, silicon is generally transported by following the transpiration flow from the roots towards the aerial parts where it is accumulated and precipitated in order to form biogenic opals known as phytoliths. The extent of silicon accumulation is more or less important depending on the variety of the plant. In a particular embodiment, the plant is a silicon-accumulating plant.

In the meaning of the invention, the term “silicon-accumulating plant” means a plant that contains more than 1% by weight of Si relative to the weight of the dry mass of the plant (hereinafter w/w) and a Si/Ca molar ratio of >1. Silicon-accumulating plants in particular comprise bryophytes, gramineae, cyperaceae, and musaceae.

Plants that are considered to be non-accumulating are those that contain less than 0.5% of silicon (w/w of the dry mass of the plant). Plants that do not accumulate silicon comprise in particular gymnosperms and dicotyledonous plants.

In a particular embodiment, the plant is selected from rice, wheat, oats, sugar cane, barley, soya, and maize, preferably rice.

Advantageously, the plant is not in an iron-deficient condition. Thus, silicon can be used to stimulate iron absorption when a sufficient quantity of iron in the soil is available to the plant.

In the context of the invention, the term “stimulating absorption” means a sharp increase in absorption and/or an improvement in the absorption mechanisms. Thus, the present invention concerns the use of silicon as a stimulant for iron absorption mechanisms in a plant. The present invention also provides the use of silicon to increase iron absorption in a plant.

In the context of the invention, the term “iron absorption” should be understood to mean absorption of iron present in the soil. In a plant, the iron present in the soil is thus absorbed by the roots. Advantageously, the iron is either absorbed in the form of ferrous iron (Fe⁺⁺), preferably for plants using strategy 1 (for tomatoes, peas, or arabidopsis, for example), or in the form of the siderophoric Fe⁺⁺⁺ complex for the plants using strategy 2 (for example for corn, barley, or rice).

In a particular embodiment, the soil has an acidic or neutral pH. The absorption of iron in an acidic or neutral soil is particularly advantageous, because the cation Fe⁺⁺, which is the form that can be assimilated by the plant, is not or is only slightly oxidized.

In the context of the present invention, an effective quantity of silicon is supplied to the plant in order to stimulate iron absorption. Thus, in a particular embodiment, the silicon is supplied to the plant in a quantity that is effective for increasing iron absorption by the plant by at least 10%, at least 15%, at least 20%, at least 25%, at least 30%, advantageously at least 30%, at least 35%, at least 40%, at least 45%, advantageously at least 50%, at least 55%. In other words, the silicon supplied to the plant can be used to increase the quantity of iron in the plant by at least 10%, at least 15%, at least 20%, at least 25%, at least 30%, advantageously by at least 30%, at least 35%, at least 40%, at least 45%, advantageously by at least 50%, at least 55%.

The increase in absorption is measured by determining the iron content in the plant. The term “increase” means with respect to the plant before supplying silicon, for example with respect to the plant that has not been supplied with any silicon. The iron “content” is expressed as w/w of dry mass, which corresponds to the mass of iron contained in a sample of dried plant. The iron content is measured using an appropriate analysis method.

The silicon may be supplied to the plant via the roots or via the foliage. In a particular embodiment, the silicon is supplied to the plant:
either in liquid form in root nutrient solutions, for example in a quantity of 0.5 grams per liter (g/L) to 5 g/L, and preferably of the order of 1 g/L;
or in liquid form in foliage nutrient solutions, for example in a quantity of 10 g/L to 50 g/L, and preferably of the order of 30 g/L;
or in solid form, for example in powdered or granulated fertilizers, for example in a quantity of 10 kilograms per metric tonne (kg/t) to 100 kg/t and preferably of the order of 50 kg/t.

In a particular embodiment, the silicon is supplied to the plant in a quantity of 2 kilograms per hectare (kg/ha) to 1000 kg/ha. In this embodiment, the silicon is advantageously distributed uniformly over a field or plant crop.

Silicon may also be used as a complement in fertilizing compositions such as fertilizers, as a iron absorption stimulant in a plant. The silicon may be associated with other fertilizing substances conventionally used in fertilizing compositions. In a particular embodiment in accordance with the invention, an effective quantity of silicon is used in a fertilizing composition in association with one or more fertilizing substances. Fertilizing substances that are capable of being used in association with silicon may have a variety of natures and may be selected, for example, from urea, ammonium sulfate, ammonium nitrate, natural phosphate, potassium chloride, ammonium sulfate, magnesium nitrate, manganese nitrate, zinc nitrate, copper nitrate, phosphoric acid, boric acid, iron sulphate, and chelated iron complexes. Advantageously, the fertilizing substance used in association with silicon is selected from urea, ammonium sulfate, ammonium nitrate, nitrogenous solution, and/or potassium nitre.

The invention also envisages a method for stimulating iron absorption in a plant, characterized in that it comprises supplying an effective quantity of silicon to said plant or to soils.

The silicon may be supplied to the plant via the roots or via the foliage. In a particular embodiment, the silicon is supplied to the plant:
either in liquid form in root nutrient solutions, for example in a quantity of 0.5 g/L to 5 g/L, and preferably of the order of 1 g/L;
or in liquid form in foliage nutrient solutions, for example in a quantity of 10 g/L to 50 g/L, and preferably of the order of 30 g/L;
or in solid form, for example in powdered or granulated fertilizers, for example in a quantity of 10 kg/t to 100 kg/t and preferably of the order of 50 kg/t.

In a particular embodiment, the silicon is supplied to the plant in a quantity of 2 kg/ha to 1000 kg/ha. In this implementation, the silicon is advantageously distributed uniformly over a field or plant crop.

In a particular embodiment, the method in accordance with the invention further comprises supplying an effective quantity of iron in the form of “EDTA, 2NaFe, H₂O” to said plant or to soils. Specifically, the inventors have observed that iron in the form of “EDTA, 2NaFe, H₂O” associated with silicon can be used to stimulate iron absorption in a plant to a significant extent. The supply of of “EDTA, 2NaFe, H₂O” may be supplied before supplying silicon, after supplying silicon, or at the same time as the silicon is supplied, preferably at the same time as the silicon is supplied.

The present invention is illustrated below by the following non-limiting examples.

In these examples, unless indicated otherwise, percentages are expressed by weight and the temperature is ambient temperature.

### KEY TO FIGURES

FIG. 1: a graph showing the biomass of a rice plant, i.e. the dry mass of a rice plant, (i) supplied with a feed that includes silicon (Na₂SiO₃), i.e. the bar “+Si”, and (ii) supplied with a feed that does not include silicon, i.e. the bar “−Si”. The graph shows an increase of 60% for the biomass of plants supplied with feed including silicon compared with plants supplied with feed not including silicon.

FIG. 2: a graph showing the quantity of silicon in a rice plant (i) supplied with a feed that includes silicon (Na₂SiO₃), i.e. the bar “+Si” and (ii) supplied with a feed that does not include silicon, i.e. the bar “−Si”. The graph shows an increase of 44% in the quantity of silicon in plants supplied with feed including silicon compared with plants supplied with feed not including silicon. The graph shows that silicon is absorbed by the plant.

FIG. 3: a graph showing the quantity of iron in a rice plant (i) supplied with a feed that includes silicon (Na₂SiO₃), i.e. the bar “+Si”, and (ii) supplied with a feed that does not comprise silicon, i.e. the bar “−Si”. The graph shows an increase of 54% in the quantity of iron in plants supplied with feed including silicon compared with plants supplied with feed that does not include silicon. The graph shows that silicon stimulates the absorption of iron.

### EXAMPLES

### Example 1: Preparation of Plant Material

Grains of rice, Oryza sativa L. Var ADRET, were kept at +4° C. the day before germination was commenced in order to ensure homogeneous emergence. They were then sown onto a layer of perlite in tanks containing demineralized water and were left in darkness for 10 days before being brought into the light. After 7 days, the plantlets were pricked out into 8 L tanks containing a Hoagland solution (Table 1).

TABLE 1
Composition of a Hoagland solution

| | [Final conc] mM |
|---|---|
| Macroelements | |
| CO(NH₂)₂ | 1 |
| KCl | 0.1 |
| CaCl₂ | 0.18 |
| KH₂PO₄ | 0.3 |
| MgSO₄, 7H₂O | 0.27 |
| EDTA, 2NaFe, H₂O | 0.2 |
| Microelements | |
| H₃BO₃ | 9.4 |
| MnSO₄, H₂O | 6.7 |
| CuSO₄, 5H₂O | 0.16 |
| ZnSO₄, 7H₂O | 0.15 |
| (NH₄)₆Mo₇O₂₄, 4H₂O | 0.015 |
| CoCl₂, 6H₂O | 0.1 |
| NiCl₂ | 0.04 |

### Feed Including Silicon (+Si)

1.5 millimoles (mM) silicon was supplied to the plantlets in the form of sodium silicate (Na₂SiO₃) which had been neutralized with HCl (1M, 30 milliliters (mL) for 8 liters (L) of nutrient solution), in order to encourage the formation of Si(OH)₄, in accordance with the reaction scheme below.

NaSiO₃+2HCl+H₂O→Si(OH)₄+NaCl

The nutrient solution was changed every 2 days and the pH was adjusted to the range 5.6 to 6. The experiment was carried out in a growth chamber at +22° C. with a twelve hours on twelve hours off 12 h/12 h photoperiod under neon lights (Lumilux cool daylight, 36 watts (W). The plants were harvested 14 days after application of the treatments.

Iron was supplied to the Hoagland nutrient solution in the form of chelated iron (EDTA, 2NaFe, H₂O) in a final concentration of 0.2 mM.

### Feed not Including Silicon (−Si)

The same experiment was carried out using Hoagland solution as the nutrient solution, but without adding silicon.

The nutrient solution was changed every 2 days and the pH was adjusted to the range 5.6 to 6. The experiment was carried out in a growth chamber at +22° C. with a 12 h/12 h photoperiod under neon lights (Lumilux cool daylight, 36 W). The plants were harvested 14 days after application of the treatments.

### Example 2: Measurement of Physiological Parameters of the Plant

### 1. Determination of Foliage and Root Biomasses

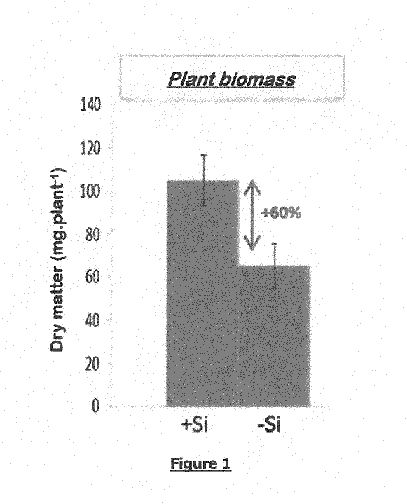

Four batches of three plants harvested in Example 1 were made up for each of the cultivation conditions (+Si and −Si) (1 batch of 3 plants=1 biological repeat). The aerial parts (leaves and stems) and root parts of each plant were separated, weighed (fresh biomass) then finely ground in liquid nitrogen. The measurement of the biomass of a whole plant is shown in FIG. 1.

Conclusion: the plants treated with silicon exhibited a significant increase in their biomass (+60%), resulting in better growth of the rice plant.

### 2. Biochemical Analyses

Samples of fresh ground material (obtained as described in point 1) were freeze-dried for 48 h for each of the biological repeats. These samples were used to determine the dry matter and for the silicon (Si) and iron analysis using ICP-OES (Inductively Coupled Plasma-Optical Emission Spectroscopy).

The series of treatments was carried out systematically for each of the biological repeats, i.e. in quadruplicate. The data obtained was presented in the form of the mean, and the variability of the results was given in the form of the standard deviation of the mean for n=4. A statistical analysis of the results was carried out using the Student's test.

### Silicon Determination

The determination of the silicon (Si) content of the samples was carried out with the aid of ICP-OES (Inductively Coupled Plasma-Optical Emission Spectroscopy, Thermo Elemental Co. Iris Intrepid II XDL). It was preceded by digestion of the freeze-dried samples for 48 h using microwaves in an acidic medium (8 mL of concentrated nitric acid and 2 mL of hydrogen peroxide per 0.1 g of dry matter).

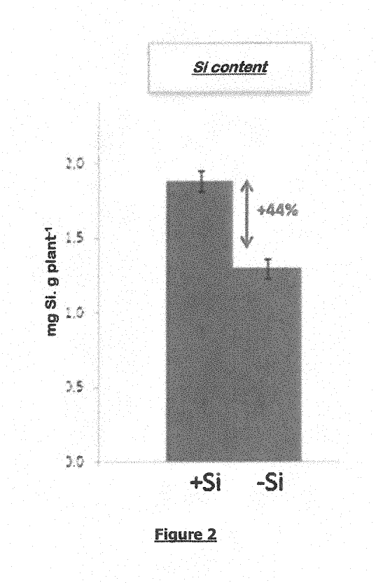

The silicon determination is shown in FIG. 2.

Conclusion: a portion of the silicon used was absorbed by the plant.

### Iron Determination

The determination of the iron (Fe) content of the samples was carried out with the aid of ICP-OES (Inductively Coupled Plasma-Optical Emission Spectroscopy, Thermo Elemental Co. Iris Intrepid II XDL). It was preceded by digestion of the freeze-dried samples for 48 h using microwaves in an acidic medium (8 mL of concentrated nitric acid and 2 mL of hydrogen peroxide per 0.1 g of dry matter).

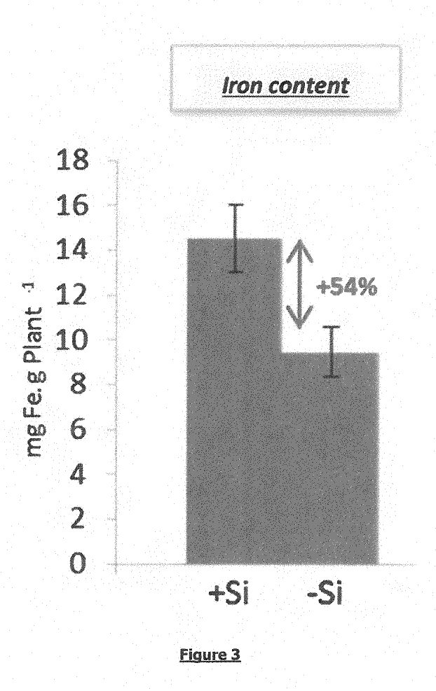

The iron determination is presented in FIG. 3.

Conclusion: the plants treated with silicon exhibited a significant increase in their iron content by +54%, which means that iron was assimilated better by the rice plant.

1. A method of stimulating iron absorption in a plant, the method comprising supplying silicon to the plant or to soil, whereby iron absorption by the plant is stimulated.

2. The method of claim 1, wherein the plant is a silicon-accumulating plant.

3. The method of claim 2, wherein the plant is selected from rice, wheat, oats, sugar cane, barley, soya and maize.

4. The method of claim 1, wherein the silicon is supplied to the plant in the form of sodium silicate (Na₂SiO₃), potassium silicate (K₂SiO₃), and/or their derivatives.

5. The method of claim 1, wherein the silicon is supplied to the plant in the form of diatomaceous earth, silicon-based soluble glass, and/or organic silicon.

6. The method of claim 1, wherein the silicon is supplied to the plant in a quantity that is effective for increasing iron absorption by the plant by at least 10%.

7. The method of claim 1, wherein the silicon is supplied to the plant in liquid form as a root nutrient solution, in liquid form as a foliage nutrient solution, or in solid form.

8.-12. (canceled)

13. The method of claim 1, further comprising supplying an effective quantity of iron in the form of “EDTA, 2NaFe, H₂O” to said plant or to soil.

14. The method of claim 3, wherein the plant is rice.

15. The method of claim 6, wherein the silicon is supplied to the plant in a quantity that is effective for increasing iron absorption by the plant by at least 30%.

16. The method of claim 6, wherein the silicon is supplied to the plant in a quantity that is effective for increasing iron absorption by the plant by at least 50%.

17. The method of claim 7, wherein silicon is supplied to the plant in liquid form, in a root nutrient solution, and in a quantity of 0.5 g/L to 5 g/L.

18. The method of claim 17, wherein silicon is supplied in a quantity of about 1 g/L.

19. The method of claim 7, wherein silicon is supplied to the plant in liquid form, in a foliage nutrient solution, and in a quantity of 10 g/L to 50 g/L.

20. The method of claim 19, wherein silicon is supplied in a quantity of about 30 g/L.

21. The method of claim 7, wherein silicon is supplied to the plant in solid form, in a powdered or granulated fertilizer, and in a quantity of 10 kg/t to 100 kg/t.

22. The method of claim 21, wherein silicon is supplied in a quantity of about 50 kg/t.
